(19) United States
(12) Patent Application Publication
(10) Pub. No.: US 2026/0070209 A1
(43) Pub. Date: Mar. 12, 2026

(54) A DEVICE FOR CLEANING FOOTWEAR

(71) Applicant: Luca Musso, Milano, MI (IT)

(72) Inventor: Luca MUSSO, Milano, MI (IT)

(21) Appl. No.: 18/703,821

(22) PCT Filed: Oct. 27, 2022
(86) PCT No.: PCT/IB2022/060347

§ 371 Date: Apr. 23, 2024

(30) Foreign Application Priority Data
Oct. 28, 2021 (IT) 102021000027656

(51) Int. Cl. B25G 3/16; A47L 23/10

(52) U.S. Cl. CPC B25G 3/16; A47L 23/10

(57) ABSTRACT

A device for cleaning footwear, comprising a handle, a first head configured as a scraper and couplable on said handle and a second head configured as a spatula with pad and couplable on said handle alternatively with respect to said first head, wherein said handle comprises a first coupling member, said first head comprises a second coupling member, said second head comprises a third coupling member, and wherein said first coupling member and said second coupling member provide a first demountable connection means of said first head with respect to said handle configured as bayonet coupling, respectively said first coupling member and said third coupling member provide a second demountable connection means of said second head with respect to said handle configured as bayonet coupling.

The present invention concerns a device for cleaning footwear.

The documents US 2007/077113 A1 and WO 2015/166206 A1 disclose a device for cleaning footwear, which has the characteristics set forth in the pre-characterizing part of claim 1.

An object of the invention is to provide a device for cleaning footwear, which allows any encrustations or deposits of solid or paste-like substances to be removed and/or sanitizing of the footwear, and which is also pocket-sized.

Another object of the invention is to provide a device for cleaning footwear, which can be used in a comfortable and hygienically safe way.

In view of these objects, the present invention provides a device for cleaning footwear, the essential feature of which is the subject matter of claim 1.
Further advantageous features of the invention are described in the dependent claims. The features and advantages of the invention will become clearer from the following detailed description of an example of embodiment thereof, with reference to the attached drawing, which shows important details for the invention, as well as from the claims.

The features illustrated here do not necessarily have to be understood to scale and are represented in such a way that the characteristics of the invention are clearly highlighted.

In the drawing:

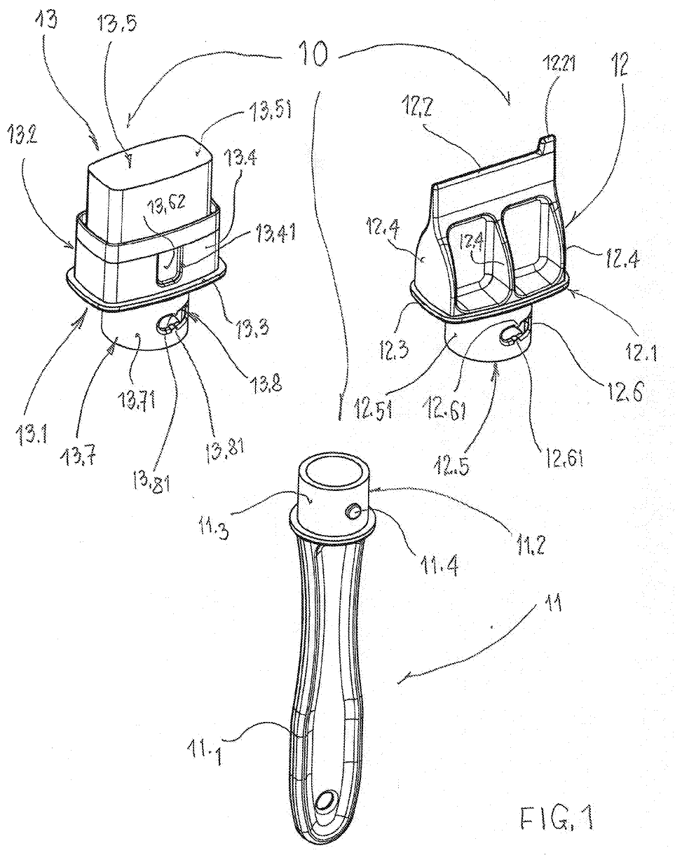

FIG. 1 is a three-quarter perspective view illustrating the device for cleaning footwear according to an example of embodiment of the invention, comprising a handle, a first head configured as a scraper and couplable on said handle (but illustrated removed therefrom) and a second head configured as a pad and couplable on said handle (but illustrated removed therefrom) alternatively with respect to said first head;

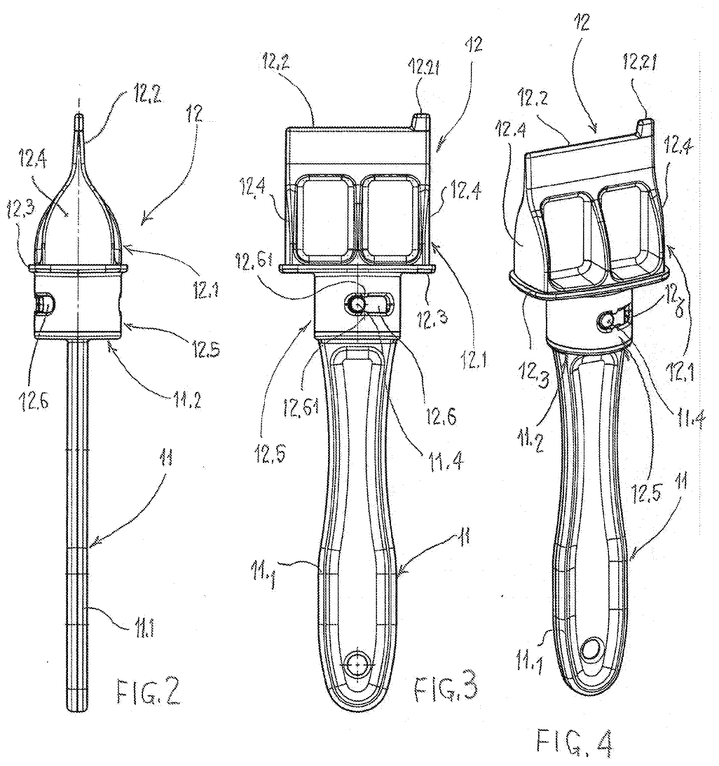

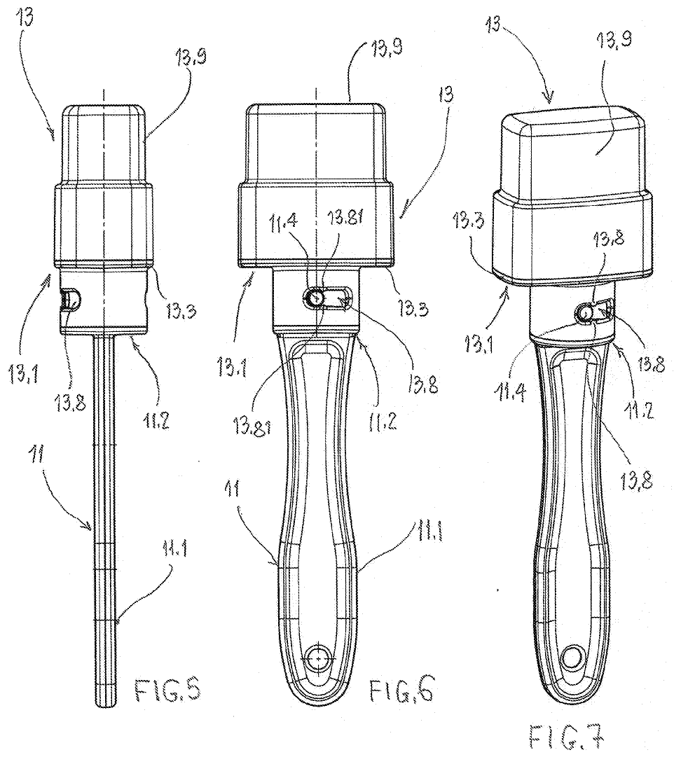

FIGS. 2, 3 and 4 are respectively front elevation, side elevation and three-quarter perspective views of the device of FIG. 1 comprising said handle with said first head coupled thereon;

FIGS. 5, 6 and 7 are front elevation, side elevation and three-quarter perspective views, respectively, of the device of FIG. 1 comprising said handle with said second head coupled on said handle and with protective cap of said second head;

FIG. 8 is a top plan view of the device of FIG. 6;

FIG. 9 is a sectional view according to the line A-A of FIG. 8;

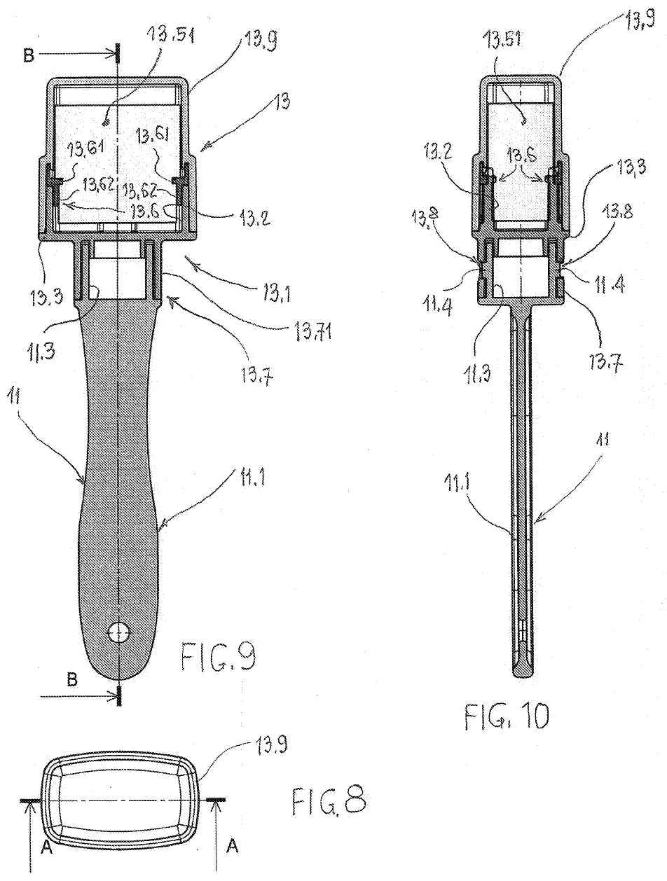

FIG. 10 is a sectional view according to the line B-B of FIG. 9.

With reference to FIG. 1 of the drawing, 10 denotes as a whole the device for cleaning footwear according to the illustrated example of embodiment of the invention.

With reference also to the other figures of the drawing, said device 10 comprises a handle 11, a first head 12 configured as a scraper and couplable on said handle 11, and a second head 13 configured as a spatula with pad and couplable on said handle, alternatively with respect to said first head 12, as will be more apparent below.
Said handle 11 is made, for example, of plastic material and comprises a gripping part 11.1 and a first coupling member 11.2, provided integral at one end of said gripping part 11.1 and shaped, in the example illustrated, as a tubular bushing 11.3, having at least one integral external boss 11.4, in the form of pin (in the example illustrated, said bushing 11.3 has two diametrically opposed external bosses 11.4, FIG. 10).
Said first head 12 configured as a scraper is made, for example, of plastic material and comprises a supporting body 12.1 and a linear blade 12.2 (preferably not sharp) provided integral at a first end of said supporting body 12.1. A base plate 12.3 is provided integral at a second end of said supporting body 12.1 opposite said blade 12.2 and is connected to said blade 12.2 by a plurality of integral ribs 12.4, projecting from a first face of said base plate 12.3. In particular, said blade 12.2 comprises, at one end, a finger-shaped coplanar boss 12.21.
Moreover, said base plate 12.3 supports a second coupling member 12.5 shaped as integral tubular collar 12.51, extending from a second face of said plate 12.3, opposite said first face, and configured to be fitted, externally and in coaxial arrangement, with respect to said first coupling member 11.2 of said handle 11, in positive mechanical engagement with respect to said bushing 11.3, producing coupling of said first head 12 on said handle 11, with the possibility of relative rotation.
Said tubular collar 12.51 has at least one slotted hole 12.6 (in the example illustrated, said collar 12.51 has two diametrically opposed slotted holes 12.6). provided in its side wall and configured to receive internally said external boss 11.4 of said bushing 11.3, when said first head 12 is coupled on said bushing 11.3 of said handle 11. In particular, said at least one slotted hole 12.6 has, in proximity of a first end zone, a pair of opposing teeth 12.61, projecting internally and configured to provide a narrowing (i.e., a reduction of the opening) in said at least one slotted hole, wherein the distance between said opposing teeth 12.61 is slightly smaller than the overall sizes of said at least one external boss 11.4 of said bushing 11.3 of the handle 11.
Said first coupling member 11.2 and said second coupling member 12.5 provide a first demountable connection means of said first head 12 with respect to said handle 11 configured as bayonet coupling.
By means of this arrangement, when said first head 12, by means of said second coupling member 12.5, is coupled on said handle 11, at said first coupling member 11.2, and said at least one external boss 11.4 of said bushing 11.3 engages said at least one slotted hole 12.6 of said collar 12.51 (in a second end zone of said hole 12.6, which is distal from said first end zone and which is sized to be easily accessible for said boss 11.4), by manually rotating, in a first direction of rotation, said first head 12 with respect to said handle 11 (i.e., by rotating the collar 12.51 with respect to the bushing 11.3), said boss 11.4 is forced to pass beyond said teeth 12.61, and is thus retained in said second end zone of said at least one hole 12.6 against undesirable escape from said hole. It must be noted that the opposite sides of said at least one slotted hole 12.6 are slightly converging with each other in said second end zone of said hole. In this way, stable and solid connection of the first head 12 configured as scraper with respect to the handle 11 is achieved. This connection is easily demountable, by rotation of said first head 12 with respect to the handle 11 in the opposite direction of rotation.
Said second head 13 configured as spatula with pad is made, for example, of plastic and comprises:
a supporting body 13.1 configured as container 13.2, which has a back wall 13.3 and a side wall 13.4; two opposing openings 13.41 being provided in said side wall 13.4;
a pad 13.5, comprising a cleaning mat 13.51 in deformable/flexible material and suitable to be soaked with a detergent/sanitizing liquid substance, for example made of spongy plastic, felt, or other similar material;
a frame 13.6 (FIGS. 9, 10) for mounting said cleaning mat 13.51 of the pad 13.5 with respect to said container 13.2 of said second head 13, wherein said frame 13.6 comprises, along its inner contour, a plurality of teeth 13.61 surrounding and engaging said mat 13.51, and, along its outer contour, a pair of elastic teeth 13.62, configured to engage, respectively, with elastic snap connection, said two opposing openings 13.41 provided in the side wall 13.4 of said container 13.2.
   By means of this arrangement, after mounting the frame 13.6 on the cleaning mat 13.51 and inserting said frame 13.6 into the container 13.2 of said second head 13, automatic stable and solid mounting of the pad 13.5 in the supporting body 13.1 is achieved, thanks to the elastic engagement of the teeth 13.62 of the frame 13.6 in the respective openings 13.41 of the container 13.2. Conversely, by manually and simultaneously urging the two elastic teeth 13.41 towards the inside of the container 13.2, the frame 13.6, and with it the pad 13.5, can be easily removed from the container 13.2. It must be noted that the cleaning mat 13.51 of the pad 13.5 extends for a substantial part of its height beyond said container 13.2.
   On the other hand, said bottom wall 13.3 of said supporting body 13.1 supports a third coupling member 13.7 shaped as integral tubular collar 13.71, extending from a face of said wall 13.3, opposite said container 13.2, and configured to be fitted, externally and in coaxial arrangement, with respect to said first coupling member 11.2, in positive mechanical engagement with respect to said bushing 11.3 of said handle 11, producing the coupling of said second head 13 with respect to said handle, with the possibility of relative rotation. Said collar 13.71 has at least one slotted hole 13.8 (in the example illustrated, said collar 13.71 has two diametrically opposed slotted holes 13.8), provided in its side wall and configured to receive internally said at least one external boss 11.4 of said bushing 11.3, when said second head 13 is coupled on said bushing 11.3 of said handle 11. In particular, said at least one slotted hole 13.8 has, in proximity of a first end zone, a pair of opposing teeth 13.81, projecting internally and configured to provide a narrowing (i.e., a reduction of the opening) in said at least one slotted hole, wherein the distance between said opposing teeth 13.81 is slightly smaller than the overall size of said external boss 11.4 of said bushing 11.3 of the handle 11.
   By means of the aforesaid arrangement, said first coupling member 11.2 and said third coupling member 13.7 provide a second demountable connection means of said second head 13 with respect to said handle 11 by means of bayonet coupling.
   The operation of said bayonet coupling is the same as that explained above with reference to the demountable connection of the first head 12 with respect to the handle 11.
   It will be noted that at least said third head 13 is provided with a removable cap 13.9, for example made of plastic, which ensures hygienic protection of the pad 13.5 and makes the head 13 easy to hold.
   Said first head 12 and said second head 13 comprise respective centring bushings, internal and coaxial with respect to the collars 12.5 and 13.7 (FIGS. 9, 10). These centring bushings mate, with positive mechanical engagement and rotatably, inside the bushing 11.3 of the handle 11, when the respective heads 12 and 13 are coupled on the handle 11, ensuring proper operation of the device 10.
   As is evident, to clean footwear, the device 10 can be used, for example, with said first head 12 configured as a scraper coupled on said handle 11 and subsequently, after removing said first head 12, with said second head 13 configured as a pad coupled on said handle 11.
   It should be noted that device 10 can be reused, for example by replacing only the second head 13 configured as spatula with pad.
   Furthermore, the device 10 can be used not only to clean the sole of a shoe and/or its upper, but also to clean other objects.
   On the other hand, as can be seen from the foregoing description, the second head 13 comprises a pad 13.5, in which the cleaning mat 13.51 is removable and replaceable after use.
   For the user, the device 10 will be presented in a package, for example a pouch, which may also include at least one disposable glove.
   On the other hand, the packaging of the device 10 may comprise, in addition to the handle 11, the first head 12 configured as scraper and the second head 13 configured as spatula with pad, also at least one other head couplable on said handle 11, for a different or complementary use with respect to that illustrated above.
   As can be seen from the foregoing, the present invention enables the purposes set out in the introduction to be achieved in a simple and effective manner.

1. A device for cleaning footwear, comprising a handle, a first head configured as scraper and couplable on said handle and a second head configured as spatula with pad and couplable on said handle, alternatively with respect to said first head, wherein said handle comprises a first coupling member, first head comprises a second coupling member, said second head comprises a third coupling member, wherein said first coupling member and said second coupling member provide a first demountable connection means of said first head with respect to said handle configured as bayonet coupling, said first coupling member and said third coupling member respectively provide a second demountable connection means of said second head with respect to said handle configured as bayonet coupling

2. The device according to claim 1, wherein said first head configured as scraper comprises a supporting body and a blade, provided integral at a first end of said supporting body.

3. The device according to claim 1, wherein said second head configured as spatula with pad comprises:
a supporting body configured as container, which has a bottom wall and a sidewall; and
a pad, comprising a cleaning mat in deformable I flexible material and suitable to be soaked with a detergent I sanitizing liquid substance, wherein said cleaning mat is inserted at least partially into said container.

4. The device according to claim 3, wherein said side wall of said container has at least one opening, and wherein said second head comprises a frame that supports said cleaning mat and comprises at least one elastic tooth, configured to engage with elastic snap connection said at least one opening of said side wall of said container.

5. The device according to claim 1, wherein:
said handle comprises said first coupling member shaped as tubular bushing;
said first head comprises said second coupling member shaped as tubular collar and configured to be fitted, in coaxial arrangement, with respect to said first coupling member, in positive mechanical engagement with respect to said bushing, producing the coupling of said first head with respect to said handle, with the possibility of relative rotation; and
said second head comprises said third coupling member shaped as tubular collar and configured to be fitted, in coaxial arrangement, with respect to said first coupling member, in positive mechanical engagement with respect to said bushing, producing the coupling of said second head with respect to said handle, with the possibility of relative rotation.

6. The device according to claim 5, wherein:
said first coupling member shaped as tubular bushing has an integral boss;
said tubular collar of said second coupling member has at least one slotted hole, configured to receive internally said boss of said bushing, when said first head is coupled on said bushing of said handle; and
said collar of said third coupling member has a slotted hole, configured to receive internally said external boss of said bushing, when said second head is coupled on said bushing of said handle.

7. The device according to claim 6,
said slotted hole of said second coupling member has, in proximity of a first end zone, a narrowing, wherein the opening of said narrowing is slightly smaller than the overall size of said boss of said bushing of the handle; and,
said slotted hole of said third coupling member has, in proximity of an end zone, a narrowing, wherein the opening of said narrowing is slightly smaller than the overall size of said boss of said bushing of the handle.

8. The device according to claim 1, wherein said device comprises a package, in which said handle, said first head, said second head and at least one disposable glove are removably arranged.
